(19) United States
(12) Patent Application Publication
(10) Pub. No.: US 2004/0204944 A1
(43) Pub. Date: Oct. 14, 2004

(54) System and method for mixing computer generated audio with television programming audio in a media center

(76) Inventor: Michael J. Castillo, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/414,079

(22) Filed: Apr. 14, 2003

(51) Int. Cl. G10L 19/00

(52) U.S. Cl. 704/500

(57) ABSTRACT

A system and method for enabling mixed audio output from a media center. Audio signals from a processing system within the media center are sent to an audio mixer codec. Audio signals from a multimedia processing device within the media center are also sent to the audio mixer codec. The audio signals from the multimedia processing device are decoded and mixed with the audio signals from the processing system. The mixed audio signal is then AC3 encoded. The AC3 encoded signal is output over a digital interface, such as a Sony/Philips Digital Interface (S/PDIF).

### BACKGROUND OF THE INVENTION

1. Field of the Invention

The present invention is generally related to the field of digital signal processing. More particularly, the present invention is related to a system and method for mixing audio from a processing system with audio from a digital television broadcast in a set-top box.

2. Description

Consumer demand for digital programming is on the rise. Television content providers, such as, but not limited to, cable and satellite providers, are increasingly providing customers with digital programming (i.e., television broadcasts). Digital television broadcasts are delivered to customers using a variety of mediums, such as, but not limited to, coaxial and fiber-optic cables, copper phone lines, and over the air via radio frequency waves. Digital television broadcasts are generally compressed using compression algorithms to increase the total amount of programming that the content provider can transmit. Example compression algorithms include MPEG2 (Motion Picture Experts Group 2) Standard (ISO/IEC International Standard 13818 (November 1994)) and MPEG 4 Standard (ISO/IEC International Standard 14496 (December 1998). Audio content is included in the MPEG stream and can be encoded using a variety of algorithms including AC3 (Audio Coding 3), an audio coding scheme developed by the Dolby Company (i.e., Dolby Digital).

The compressed digital signals are typically received in the home using a device known as a set-top-box. The set-top-box decompresses the digital signals and formats the decompressed digital signals for display.

One type of set-top-box is a media center. Media centers are complex set-top boxes that include high quality processors, such as, but not limited to, mobile Intel® processors manufactured by Intel Corporation. The high quality processors add personal computer (PC) functions to the set-top box. Such functions enable the customer or user to access online interactive services, electronic program guides, and games as well as create home networks. With each of these functions, the processor may be capable of producing sounds associated with serving the Web, reviewing the electronic program guide, playing electronic games, controlling the home network, etc.

In the case of a home network, the media center may act as a home media server for serving digital television programs to other devices in the home, such as, but not limited to, one or more computers over a standard wired connection or wireless connection, a handheld tablet or personal digital assistant (PDA) over a wireless connection, etc. The media center may also connect to the telephone, air conditioning and heating units, security system, utility meters, and other household appliances to enable control of these devices through the media center.

Media centers provide high quality audio output through an S/PDIF (Sony/Philip Digital Interface). The S/PDIF interface provides a standard format for transferring data between two digital audio components over a standard cable. Typically, MPEG signals received by the media center are decompressed and AC3 audio content is stripped from the signal. The AC3 audio is then output to an audio receiver or decoded and output to local speakers. In many instances, the AC3 audio is output via the S/PDIF interface to an audio receiver.

If a user of the media center is multi-tasking, such as, for example, watching a digital television broadcast and surfing the Web, the user may want to hear the sounds produced by the high quality processor when surfing the Web as well as the AC3 audio from the digital television broadcast. Unfortunately, with a typical media center, only one of the sounds produced by the high quality processor or the AC3 audio from the digital television broadcast may be output at any given time. Thus, if the user is only surfing the Web, the user will be able to hear the sounds associated with surfing the Web. If while surfing the Web, the user turns on the audio receiver to hear the AC3 audio associated with a digital television broadcast, the user will no longer be able to hear the sounds associated with Web surfing. The user will only hear the AC3 audio, which provides six channels of audio for enhanced sound quality and full surround sound.

Thus, what is needed is a media center that enables both AC3 audio from a digital broadcast as well as audio generated from a processing system function to be output simultaneously.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a diagram illustrating a typical media center in which audio associated with a processing system and audio from a digital broadcast may not be heard simultaneously.

FIG. 2 is an exemplary block diagram illustrating an exemplary processing system within a media center.

FIG. 3 is a block diagram illustrating a media center for enabling both audio associated with a processing system and audio from a digital broadcast to be heard simultaneously according to an embodiment of the present invention.

FIG. 4 is a flow diagram describing an exemplary method for enabling a media center to provide audio associated with a processing system and audio from a digital broadcast simultaneously according to an embodiment of the present invention.

### DETAILED DESCRIPTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Embodiments of the present invention are directed to a system and method for mixing processor-generated audio with audio from a digital broadcast in a media center. Although embodiments of the present invention are described with respect to a media center, other types of set-top boxes that enable a user to perform PC functions as well as receive multimedia broadcasts may also be used.

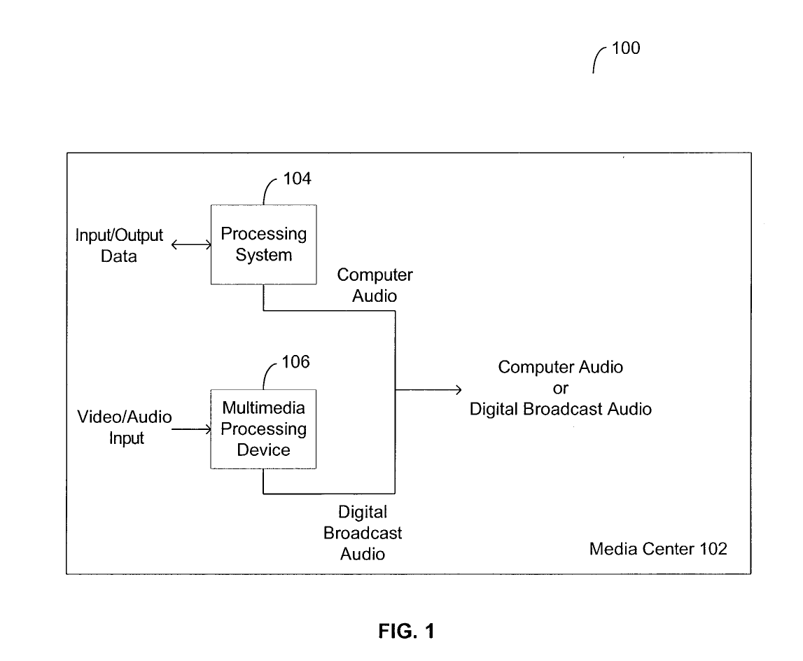

FIG. 1 is a diagram 100 illustrating a typical media center in which audio associated with a processing system and audio from a digital broadcast are incapable of being heard simultaneously. Diagram 100 shows a media center 102. Media center 102 comprises a processing system 104 coupled to a multimedia processing device 106.

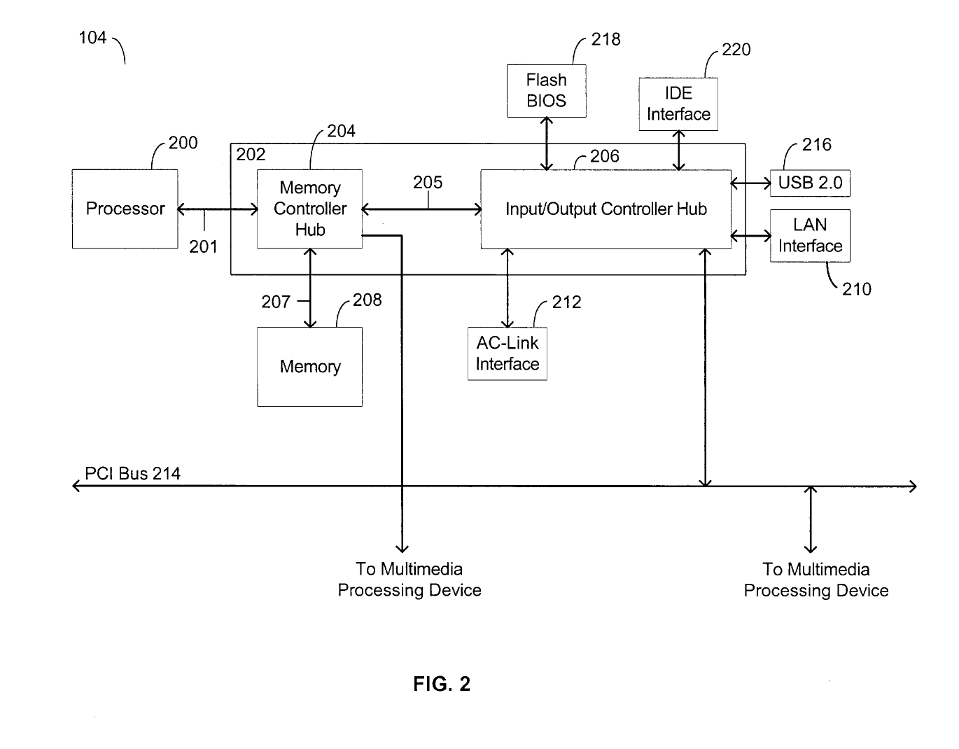

Processing system 104 enables media center 102 to function as a multimedia desktop computer. Media center 102 may provide such services as home networking, Internet Protocol (IP) telephony, interactive television, video-on-demand (VoD), videoconferencing, high-speed Internet TV services, etc. An example implementation of processing system 104 is shown in FIG. 2. Various embodiments are described in terms of this exemplary processing system 104. After reading this description, it will be apparent to a person skilled in the relevant art how to implement embodiments of the invention using other processing systems and/or processing architectures.

Processing system 104 includes one or more processors, such as processor 200. Processor 200 may include, but is not limited to, a mobile Intel® processor, such as the Mobile Intel® Pentium® III Processor-M manufactured by Intel Corporation.

Processor 200 is connected to a system chipset 202. Chipset 202 acts as a traffic cop for processing system 104 by controlling all data transfers between processor 200 and components within chipset 202. Chipset 202 comprises a memory controller hub (MCH) 204 and an input/output controller hub (ICH) 206. Processor 200 is connected to MCH 204 via a front side bus (FSB) 201. MCH 204 is connected to ICH 206 via a hub interface 205.

MCH 204 controls front side bus 201, memory, and hub interface 205. MCH 204 is the central hub for all data passing through processing system 104. MCH 204 controls the speed in which information is passed to processor 200 and provides memory support.

A main memory 208 is connected to MCH 204 via a memory interface 207. Main memory 208 may include, but is not limited to, Synchronous Dynamic Random Access Memory (SDRAM), Double-Rate Synchronous Dynamic Random Access Memory (DDR-SDRAM), and Rambus Dynamic Random Access Memory (RDRAM) (developed by Rambus, Inc.). MCH 204 controls the speed at which data is transferred between MCH 204 and main memory 208. In embodiments, example speeds may include 133 MHz, 266 MHz, etc. MCH 204 also controls how much memory MCH 204 can address or use. In embodiments, addressable amounts may include 512 Mbytes, 1 Gbyte, etc.

In one embodiment, a graphics controller (not shown) may be included in MCH 204. In this embodiment, MCH 204 also interfaces to an accelerated graphics port (APG). Having the graphics controller within MCH 204 enables the graphics controller to access main memory 208 at a faster speed. In one embodiment, the AGP interface allows the graphics controller to access main memory 208 at over 1 Gigabyte per second.

As previously indicated, MCH 204 is connected to ICH 206 via hub interface 205. ICH 206 controls various peripheral interfaces in processing system 104. By directly connecting to MCH 204, ICH 206 provides direct communication with graphics and memory for faster access to peripherals. Peripheral interfaces may include, but are not limited to, Integrated Device Electronics (IDE) interfaces 220, local-area-network (LAN) interfaces 210, AC-link (Audio Code-link) interfaces 212, a Peripheral Component Interconnect (PCI) interface 214, and Universal Serial Bus (USB) interfaces 216.

IDE interfaces 220 are used to connect secondary memory to processing system 104. Secondary memory may include, for example, a hard disk drive and/or a removable storage drive, representing a floppy disk drive, a magnetic tape drive, an optical disk drive, etc. The removable storage drive can read from and/or write to a removable storage unit in a well-known manner. A removable storage unit represents a floppy disk, a magnetic tape, an optical disk, etc., which is read by and written to by the removable storage. As will be appreciated, removable storage units include computer usable storage mediums having stored therein computer software and/or data.

LAN interfaces 210 and AC-link interfaces 212 are referred to as communications interfaces. Communications interfaces allow software and data to be transferred between processing system 104 and external devices. For example, AC-link interfaces 212 are used for audio and telephony. Peripherals such as modems and other audio peripherals may be used. AC-link audio delivers six channels of audio for enhanced sound quality and full surround sound capability for live broadcast and other digital programming. LAN interfaces 210 are used for connecting processing system 104 to other networks. An example of a LAN interface 210 may include, but is not limited to, a communications port.

Software and data transferred via a communications interface are in the form of signals which may be electronic, electromagnetic, optical or other signals capable of being received by communications interfaces, such as LAN interfaces 210 and AC-link interfaces 212. The signals are provided to the communications interface via a communications path (i.e., channel). A channel carries the signals and may be implemented using wire or cable, fiber optics, a phone line, a cellular phone link, a wireless link, and other communications channels.

PCI bus 214 is a local bus interface, and is well known to those skilled in the relevant art(s). PCI bus 214 may be used for add-in cards, such as, but not limited to, a network interface (such as an Ethernet card), a PCMCIA (personal computer memory card international association) slot and card, a wireless LAN interface, network interface cards, etc.

In one embodiment, PCI bus 214 may be used to extend secondary memory. In this instance, secondary memory may include other similar means for allowing computer programs or other instructions to be loaded into processing system 104. Such means may include, for example, a removable storage unit and interface. Examples of such may include a program cartridge and cartridge interface (such as that found in video game devices), a removable memory chip (such as an EPROM (erasable programmable read-only memory) or PROM (programmable read-only memory)) and associated socket, and other removable storage units and interfaces which allow software and data to be transferred from a removable storage unit to processing system 104.

USB interfaces 216 may be used to connect external peripheral devices to processing system 104. External peripheral devices may include, but not limited to, mice, modems, keyboards, printers, cameras, and other plug-and-play peripheral components.

Other types of interfaces may also be connected to ICH 206. For example, a LPC (low pin count) interface may interconnect to a super input output (I/O) device which comprises a plurality of I/O ports, such as serial, parallel, etc. The super input output device may be used as an interface to a front panel, a security digital (SD) card, a memory stick, a flash memory, etc. In an embodiment where the front panel may be controlled with an infrared (IR) remote control, the super input output port may include an infrared IR port for communicating with the IR remote control.

ICH 206 may also include a flash BIOS 218. Flash BIOS 218 contains software used to initialize all system hardware in processing system 104. The software is recorded on a flash memory chip (not shown), which can be updated if necessary.

In this document, the term “computer program product” refers to removable storage units and signals. These computer program products are means for providing software to processing system 104. Embodiments of the invention may be directed to such computer program products.

Computer programs (also called computer control logic) are stored in main memory 208, and/or a secondary memory device and/or in computer program products. Computer programs may also be received via communications interfaces. Such computer programs, when executed, enable processing system 104 to perform the features of the present invention as discussed herein. In particular, the computer programs, when executed, enable processor 200 to perform the features of embodiments of the present invention. Accordingly, such computer programs represent controllers of processing system 104.

Returning to FIG. 1, multimedia processor device 106 is similar to a set-top box. Multimedia processor system 106 accepts as input compressed digital signals from television content providers, decompresses the compressed digital signals, and formats the decompressed digital signals for display.

With media center 102, a user will only be able to hear audio from processing system 104 or AC3 audio from multimedia processing device 106. For example, a user watching a digital television broadcast and surfing the Web may want to hear the sounds produced by processing system 104 when surfing the Web as well as the AC3 audio from the digital television broadcast via multimedia processing device 106. If at first the user is only surfing the Web, the user will be able to hear the sounds from processing system 104 associated with surfing the Web. If while surfing the Web, the user turns on the audio receiver to hear the AC3 audio associated with a digital television broadcast via multimedia processing device 106, the user will no longer be able to hear the sounds associated with Web surfing. The user will only hear the AC3 audio that provides six channels of audio for enhanced sound quality and full surround sound.

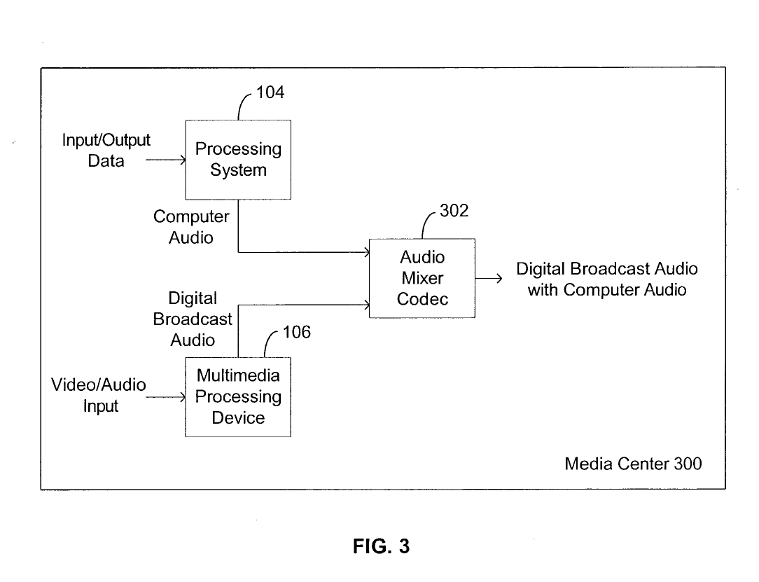

FIG. 3 is a block diagram illustrating a media center 300 for enabling both audio associated with a processor and audio from a digital broadcast to be heard simultaneously according to an embodiment of the present invention. Media center 300 is similar to media center 100, except for the addition of an audio mixer codec 302. Audio mixer codec 302 may be implemented using hardware, software, or a combination thereof.

In an embodiment where audio mixer codec 302 is implemented using software, the software may be stored in a computer program product and loaded into processing system 104 using a secondary memory device, a removable storage drive, or a communications interface. The control logic (software), when executed by processing system 104, causes processing system 104 to perform the functions of the invention as described in embodiments herein.

In another embodiment, audio mixer codec 302 may be implemented primarily in hardware using, for example, hardware components such as application specific integrated circuits (ASICs). Implementation of hardware state machine(s) so as to perform the functions described in embodiments herein will be apparent to persons skilled in the relevant art(s). In yet another embodiment, audio mixer codec 302 may be implemented using a combination of both hardware and software.

Audio mixer codec 302 enables the mixing of audio signals as well as encoding and decoding audio signals. The addition of audio mixer codec 302 to media center 300 enables audio from processing system 104 (via AC-link interface 212) to be mixed with audio from multimedia processing device 106. The audio from multimedia processing device 106 is decoded by audio mixer codec 302. The decoded multimedia processor audio is then mixed with the audio from processing system 104. The mixed audio signal is encoded using an AC-3 audio coding scheme developed by the Dolby Company. The encoded mixed audio signal provides one audio signal output that includes audio from processing system 104 as well as audio from multimedia processing device 106 when the two audio signals occur simultaneously. Otherwise, only one of the audio signals will be heard. Thus, a user will not only hear the multimedia broadcast audio input from a cable or satellite provider, but will hear the audio generated from processing system 104 as the user interacts with processing system 104.

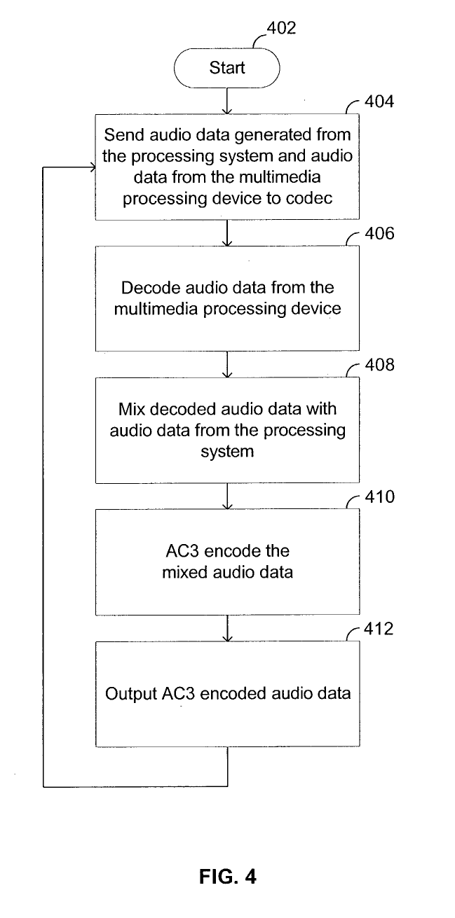

FIG. 4 is a flow diagram 400 describing an exemplary method for enabling a media center to provide audio associated with a processing system and audio from a digital broadcast simultaneously according to an embodiment of the present invention. The invention is not limited to the embodiment described herein with respect to flow diagram 400. Rather, it will be apparent to persons skilled in the relevant art(s) after reading the teachings provided herein that other functional flow diagrams are within the scope of the invention. The process begins with block 402, where the process immediately proceeds to block 404.

In block 404, audio data generated from processing system 104 and audio data from multimedia processing device 106 are received by audio mixer codec 302. The audio data generated from processing system 104 may be any sound generated by a processor when interacting with a user. For example, when a user surfs the Internet, the user may make selections using a pointing device, such as a mouse, that when made cause a clicking sound to be generated. In another example, the user may be playing a video game that incorporates loud audio sounds, such as, for example, blasts, gun-fire, music, etc. The audio data from multimedia processing device 106 may be from a digital broadcast via a satellite or cable provider.

In block 406, the audio data from multimedia processing device 106 is decoded. In block 408, the decoded audio data is mixed with the audio data from processing system 104.

In block 410, the mixed audio data is AC3 encoded. AC3 audio coding scheme is the kernel for audio types such as Dolby Digital (the audio standard used in film industry), DVD (Digital Video Disk), multimedia, HDTV (High Definition Television), Dolby Surround Digital (the audio standard used in Home Theater System (HTS), and Dolby Net (used in the Internet environment).

In block 412, the AC3 encoded mixed audio data is output from audio mixer codec 302. The audio output includes audio from processing system 104 and audio from multimedia processing device 106 when the two audio signals occur simultaneously. If the two audio signals are not occurring at the same time, only one of the audio signals will be output.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What is claimed is:

1. A method for enabling mixed audio output in a media center comprising:
sending a first audio signal from a processor and a second audio signal from a multimedia device to a codec;
decoding the second audio signal;
mixing the decoded second audio signal with the first audio signal; and
encoding the mixed audio signal.

2. The method of claim 1, wherein the second audio signal comprises an AC3 (Audio Coding 3) encoded audio signal.

3. The method of claim 1, wherein encoding the mixed audio signal further comprises AC3 encoding the mixed audio signal.

4. The method of claim 1, further comprising stripping the second audio signal from a MPEG (Motion Picture Expert Group) data packet prior to the second audio signal being sent to the codec.

5. The method of claim 1, further comprising outputting the encoded mixed audio signal over a digital interface.

6. The method of claim 5, wherein the digital interface comprises a Sony/Philips digital interface (S/PDIF).

7. The method of claim 1, wherein the encoded mixed audio signal comprises audio data from the processor and audio data from the multimedia device when the two audio signals occur simultaneously, audio data from the processor only when the audio from the multimedia device is silent, and audio data from the multimedia device only when the audio from the processor is silent.

8. An article comprising: a storage medium having a plurality of machine accessible instructions, wherein when the instructions are executed by a processor, the instructions provide for sending a first audio signal from a processor and a second audio signal from a multimedia device to a codec;
decoding the second audio signal;
mixing the decoded second audio signal with the first audio signal; and
encoding the mixed audio signal.

9. The article of claim 8, wherein the second audio signal comprises an AC3 (Audio Coding 3) encoded audio signal.

10. The article of claim 8, wherein instructions for encoding the mixed audio signal further comprises instructions for AC3 encoding the mixed audio signal.

11. The article of claim 8, further comprising instructions for stripping the second audio signal from a MPEG (Motion Picture Expert Group) data packet prior to the second audio being sent to the codec.

12. The article of claim 8, further comprising instructions for outputting the encoded mixed audio signal over a digital interface.

13. The article of claim 12, wherein the digital interface comprises a Sony/Philips digital interface (S/PDIF).

14. The article of claim 8, wherein the encoded mixed audio signal comprises audio data from the processor and audio data from the multimedia device when the two audio signals occur simultaneously, audio data from the processor only when the audio from the multimedia device is silent, and audio data from the multimedia device only when the audio from the processor is silent.

15. A system for enabling mixed audio output, comprising:
a media center, the media center including a multimedia processing device coupled to a processing system; and
an audio mixer codec, the audio mixer codec coupled to the multimedia processing device and the processing system;
wherein the audio mixer codec mixes a first audio signal from the processing system with a second audio signal from the multimedia processing device and encodes the mixed audio signal.

16. The system of claim 15, wherein the multimedia processing device comprises a set-top box.

17. The system of claim 15, wherein the encoded mixed audio signal comprises an AC3 (Audio Coding 3) encoded mixed audio signal.

18. The system of claim 15, wherein the audio mixer codec decodes the second audio signal prior to mixing the second audio signal with the first audio signal, wherein the second audio signal comprises an AC3 encoded signal.

19. The system of claim 15, wherein the encoded mixed audio signal comprises audio data from the processing system and audio data from the multimedia processing device when the two audio signals occur simultaneously, audio data from the processing system only when the audio from the multimedia processing device is silent, and audio data from the multimedia processing device only when the audio from the processing system is silent.
